(19) United States
(12) Patent Application Publication
(10) Pub. No.: US 2005/0081099 A1
(43) Pub. Date: Apr. 14, 2005

(54) Method and apparatus for ensuring valid journaled file system metadata during a backup operation

(75) Inventors: Joon Chang, Austin, TX (US); Mark Allen Grubbs, Round Rock, TX (US); Gerald Francis McBrearty, Austin, TX (US); Grover Herbert Neuman, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/682,399

(22) Filed: Oct. 9, 2003

(51) Int. Cl. G06F 11/00

(52) U.S. Cl. 714/15

(57) ABSTRACT

A method and apparatus for ensuring valid journaled file system metadata during a backup operation are provided. With the method and apparatus, mechanisms are provided for suspending write I/O operations to storage devices during a point-in-time backup operation. Once the point-in-time backup operation is completed, the suspended write I/O operations are released and may then be processed by the storage system. In one exemplary embodiment, when a point-in-time operation is initiated, a point-in-time backup flag is set in a logical volume manager. In response to receiving a write I/O operation, the logical volume manager checks the status of the point-in-time backup flag to determine if a point-in-time backup operation is currently being performed. If the flag is not set, then the write I/O operation is logged and performed in a normal manner. If the flag is set, then the write I/O operation is stored in a hold queue of the logical volume manager. The write I/O is not permitted to be sent to the storage system while stored in the hold queue. When the point-in-time backup operation is completed, the suspended write I/O operations in the hold queue are permitted to be sent to the storage system and the metadata for the file system is updated to reflect the committing of the write I/O operations.

### BACKGROUND OF THE INVENTION

1. Technical Field

The present invention is directed to an improved method of performing backup operations in a computing system having a journaled or log file system. More specifically, the present invention provides a method and apparatus for ensuring the validity of the journaled file system metadata during a backup operation.

2. Description of Related Art

Virtually all computer applications (or programs) rely on storage. This storage can be used for both storing the computer code and for storing data manipulated by the code. The term “data” refers to any information, including formatting information, executable code and data for manipulation by an application program. Storage technology has developed in a variety of different directions. Accordingly, a wide variety of storage systems are available.

Because of the wide variety of storage systems that are available, it has become impractical for the person writing the computer application to also be responsible for detailed control over how data is stored on the storage system. For this and other reasons, application programs typically run on an operating system, e.g., Unix, Windows, MS DOS, Linux, and the many variations of each. Once again, however, the operating system may be used with a variety of storage systems. It would be highly inefficient to have to change the operating system, or the application programs, every time a change is made to physical storage. As a result, various layers of abstraction have evolved for viewing how data is actually stored in the storage system.

FIG. 1 illustrates one way of viewing the layers of abstraction. At the top level 10, the application program may assume that data is stored in a manner that has very little to do with how the data is placed onto the physical device. For example, the application may view the storage system as containing a number of directories and data files within the directories. Thus, in an application written for use in the Unix operating system, the application will assume that files are stored according to the Unix directory structure including hierarchical directories and files located within the directories. This assumed organization of physical storage may have very little to do with how that data is actually stored onto the actual storage devices. This view may be referred to as the “logical view” because of the separation between the logical view of data, from the application level 10, being divorced from any view of how the data is physically stored on the physical storage devices. A logical entity, such as a file, database or other construct, may be referred to at the logical level as a “logical object.”

The application level 10 interfaces with the file system level 12. The file system level 12 is concerned with how files are stored on disks and how to make everything work efficiently and reliably. Thus, the file system level 12 may be responsible for storing directory structure, and for breaking up files into constituent data blocks for storage onto a physical storage system. For example, in most implementations of Unix, each file has an associated i-node. This i-node may contain accounting and protection information and, additionally, a set of pointers to data blocks.

Relatively early in the development of computer systems, disk drives became a fundamental device for storage. Accordingly, computer operating systems have been developed assuming that memory will rely on input/output (“I/O”) to a disk drive. The file system 12, therefore, may assume one or more “volumes” which correspond to a physical storage unit such as a disk drive, or any other unit of storage, with data stored in blocks on the disk drive. The demand for storage to be available for use by applications has greatly increased. As a result, a number of separate physical devices may be required to accommodate the total amount of storage required for a system. In addition, storage systems are often changed or reconfigured.

To insulate the operating system from any changes within the physical device storage system, some mechanism is often employed to flexibly map a standard (volume) view of physical storage onto an actual physical storage system. The logical volume manager (“LVM”) 14 of FIG. 1 can help achieve this function by mapping the file system view of data storage into an intermediate layer.

Finally, the actual storage reading and writing (and, potentially, additional mapping onto physical storage devices) occurs within the physical storage system level 16, as illustrated in FIG. 1. Thus, for example, the logical volume manager 14 may map the file system level view of data into volume sizes corresponding to fixed physical storage segment sizes for storage on a physical device (e.g, block sizes). The physical storage system level 16 may then map the logical volume manager 14 level volumes onto physical storage segments (e.g., hyper-volumes discussed below). Thus, in the above examples, the mapping of application level data into actual physical storage occurs across four levels: application level 10 to file system level 12; file system level 12 to LVM level 14; LVM level 14 to physical storage system level 16; and physical storage system level 16 to the actual physical storage devices.

Problems occur in storage systems when there are failures, such as a system crash, that may cause the file system in the storage system to become corrupted. That is, when data is written to a storage system, the data is usually sent to a disk cache. The disk cache is a buffer allocated in the main memory and is intended to increase the speed of I/O operations. The problems occur when there is a system crash or failure before the data in the disk buffer has been written to the physical disk. In such a case, upon reboot of the system, the system will operate in an inconsistent manner since the system believes that the data has been written to the disk drive but, in actuality, the data has not been written to the disk drive due to the system failure. For example, a file may be deleted in the disk cache, but this deletion may not have actually been performed on the physical disk such that the file still remains on the physical disk.

It is because of such problems that databases and file systems have been provided with the ability to recover the system back to a consistent state. Although databases typically recover quickly, as the file system size grows, the recover time increases. For example, the fsck recover tool for ext2fs must scan through the entire disk partition in order to take the file system back to a consistent state. This time-consuming task creates a lack of availability for large servers with hundreds of gigabytes of disk space.

In order to provide the file system with a database-like recovery mechanism, journal or log file systems have been devised. The journal or log file systems make use of transactions. A transaction is a set of single operations that satisfy several properties. These properties are often referred to as the ACID properties of transactions. The acronym ACID stands for Atomicity, Consistency, Isolation and Durability. The most important one of these properties for purposes of the present invention is atomicity. Atomicity implies that all operations belonging to a single transaction are completed without errors or cancelled, producing no changes. This property, along with Isolation, makes the transaction appear to be non-partitionable.

The journal or log file system takes advantage of this atomicity by logging every single operation within the transaction into a log file or journal. The log entries for a transaction are comprised of metadata for the transaction. This metadata includes the control structures inside a file system, e.g., i-nodes, free block allocation maps, i-node maps, and the like.

After every single transaction, there must be a commit operation that makes the data in the disk buffer be written to physical disk storage. Therefore, if there is a system crash or other failure, the log may be traced back to the first commit statement, and the changes made by those transactions that did not commit entirely may be rolled back.

Even with the ability provided by journal or log file systems to recover a system to a consistent state, problems may still occur. One significant problem is the ability to obtain a valid device-level backup of multiple inter-related devices while the journal or log file system of those devices is active. For example, if a backup of a storage system is being performed, and the journal or log file system of the storage system is still active, then there may be transactions sent to the file system while the backup operation is being performed. As a result, the data in the backup copy of the storage system may be different from the data stored in the storage system. Thus, an inconsistency in the file system is created. Therefore, it would be beneficial to have a method and apparatus for ensuring valid journal file system metadata during a backup operation.

### SUMMARY OF THE INVENTION

The present invention provides a method and apparatus for ensuring valid journaled file system metadata during a backup operation. With the method and apparatus of the present invention, mechanisms are provided for suspending write I/O operations to storage devices during a point-in-time backup operation. Once the point-in-time backup operation is completed, the suspended write I/O operations are released and may then be processed by the storage system.

In one exemplary embodiment, when a point-in-time operation is initiated, a point-in-time backup flag is set in a logical volume manager. In response to receiving a write I/O operation, the logical volume manager checks the status of the point-in-time backup flag to determine if a point-in-time backup operation is currently being performed. If the flag is not set, then the write I/O operation is logged in the file system log and the write I/O operation is performed in a normal manner. Once the write I/O operation is completed, the file system is informed of the completion and the log entry for the write I/O operation is used to update the file system metadata.

If the backup operation flag is set, then the metadata for the write I/O operation is stored in the file system log and the write I/O operation is stored in a hold queue of the logical volume manager. The write I/O is not permitted to be committed to the logical volume while it is stored in the hold queue. As a result, the write I/O operation cannot be completed until after the backup operation is complete and thus, the file system metadata is not modified to reflect the completion of the write I/O operation until after the backup operation is complete.

When the point-in-time backup operation is completed, the completion of the point-in-time backup operation is communicated to the logical volume manager which then resets the point-in-time backup flag. In addition, the suspended write I/O operations in the hold queue are released so that they may be performed on the logical volume. When the write I/O operation is committed by the storage device(s) of the logical volume, the storage devices respond to the logical volume manager that the write I/O has been completed and, as a result, the metadata stored in the file system log for the write I/O operation is used to update the file system metadata for the logical volume. In this way, write I/Os are permitted to be sent to the file system log but are held from being committed to the storage devices, in a hold queue of the logical volume manager, until after the backup operation is completed.

Thus, as a result of the operation of the present invention, the metadata associated with the point-in-time backup copy of the data in the storage system, the data in the storage system, and the file system metadata remain consistent during the backup operation. It is only after the point-in-time backup operation is complete that the write I/O operations received during the point-in-time backup operation are permitted to be committed to the logical volume, and as a result, the metadata of the file system is updated to reflect the writing of the data to the logical volume.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating the layers of abstraction of a storage system;

FIG. 2 is an exemplary diagram of a distributed data processing system in which the present invention may be implemented;

FIG. 3 is an exemplary diagram of a server data processing device in which the present invention may be implemented;

FIG. 4 is an exemplary diagram of a client or stand-alone data processing device in which the present invention may be implemented;

FIG. 5 is an exemplary diagram of a storage system in which the present invention may be implemented;

FIG. 6 is an exemplary diagram of the primary operational components of a logical volume manager in accordance with the present invention;

FIG. 7 is a flowchart outlining an exemplary operation of the present invention with regard to setting and resetting a point-in-time backup flag in a logical volume manager;

FIG. 8 is a flowchart outlining an exemplary operation of the present invention with regard to suspending a write I/O operation during a backup operation;

FIG. 9 is a flowchart outlining an exemplary operation of the present invention with regard to releasing suspended write I/O operations in a hold queue of a logical volume manager.

### DETAILED DESCRIPTION OF THE PREFERRED EMBODIMENT

The present invention provides a mechanism for ensuring the integrity of a file system during a backup operation. More specifically, the present invention provides a mechanism for ensuring that the metadata of a file system is consistent with the state of the storage system and the metadata of the backup such that the journal or log file system may remain active during the backup operation. The mechanisms of the present invention may be employed in a distributed data processing system or in a stand-alone computing device. As such, in order to provide a context for the description of the operational components of the present invention, a brief description of a distributed data processing system and a stand-alone data processing system are provided hereafter with reference to FIGS. 2-5.

With reference now to the figures, FIG. 2 depicts a pictorial representation of a network of data processing systems in which the present invention may be implemented. Network data processing system 200 is a network of computers in which the present invention may be implemented. Network data processing system 200 contains a network 202, which is the medium used to provide communications links between various devices and computers connected together within network data processing system 200. Network 202 may include connections, such as wire, wireless communication links, or fiber optic cables.

In the depicted example, server 204 is connected to network 202 along with storage unit 206. In addition, clients 208, 210, and 212 are connected to network 202. These clients 208, 210, and 212 may be, for example, personal computers or network computers. In the depicted example, server 204 provides data, such as boot files, operating system images, and applications to clients 208-212. Clients 208, 210, and 212 are clients to server 204. Network data processing system 200 may include additional servers, clients, and other devices not shown. In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

Referring to FIG. 3, a block diagram of a data processing system that may be implemented as a server, such as server 204 in FIG. 2, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 208, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to clients 208-212 in FIG. 2 may be provided through modem 318 and network adapter 320 connected to PCI local bus 316 through add-in boards.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer pSeries system, a product of International Business Machines Corporation in Armonk, N.Y., running the Advanced Interactive Executive (AIX) operating system or LINUX operating system.

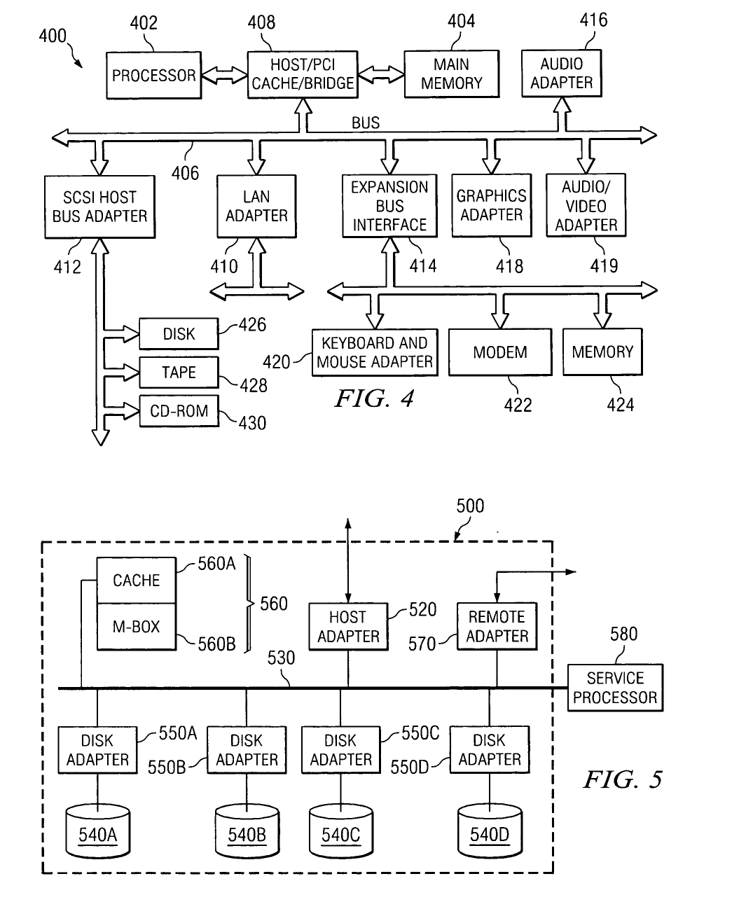

With reference now to FIG. 4, a block diagram illustrating a data processing system is depicted in which the present invention may be implemented. Data processing system 400 is an example of a client computer. Data processing system 400 employs a peripheral component interconnect (PCI) local bus architecture. Although the depicted example employs a PCI bus, other bus architectures such as Accelerated Graphics Port (AGP) and Industry Standard Architecture (ISA) may be used. Processor 402 and main memory 404 are connected to PCI local bus 406 through PCI bridge 408. PCI bridge 408 also may include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter 419 are connected to PCI local bus 406 by add-in boards inserted into expansion slots. Expansion bus interface 414 provides a connection for a keyboard and mouse adapter 420, modem 422, and additional memory 424. Small computer system interface (SCSI) host bus adapter 412 provides a connection for hard disk drive 426, tape drive 428, and CD-ROM drive 430. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as Windows XP, which is available from Microsoft Corporation. An object oriented programming system such as Java may run in conjunction with the operating system and provide calls to the operating system from Java programs or applications executing on data processing system 400. “Java” is a trademark of Sun Microsystems, Inc. Instructions for the operating system, the object-oriented programming system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash read-only memory (ROM), equivalent nonvolatile memory, or optical disk drives and the like, may be used in addition to or in place of the hardware depicted in FIG. 4. Also, the processes of the present invention may be applied to a multiprocessor data processing system.

As another example, data processing system 400 may be a stand-alone system configured to be bootable without relying on some type of network communication interfaces. As a further example, data processing system 400 may be a personal digital assistant (PDA) device, which is configured with ROM and/or flash ROM in order to provide non-volatile memory for storing operating system files and/or user-generated data.

The depicted example in FIG. 4 and above-described examples are not meant to imply architectural limitations. For example, data processing system 400 also may be a notebook computer or hand held computer in addition to taking the form of a PDA. Data processing system 400 also may be a kiosk or a Web appliance.

FIG. 5 shows a storage system 500 with which the present invention may be implemented. A host device, such as a server or client computer, may be connected to the storage device using a channel, bus or communication link 510. The channel for communication with the host device can be any suitable connection such as a Small Computer System Interface (“SCSI”), Enterprise Systems Connection Architecture (“ESCON”), or the like. Alternatively, the communication link 510 may be associated with a network connection, e.g., an intranet, a LAN, a WAN, the Internet, or the like, such that the storage system 500 is accessible by a host device via at least one network. While only one communication link 510 into the storage system 500 is shown in FIG. 5, other channels may be included.

Within the storage system 500 is a host adapter 520 that is responsible for managing and translating read and write requests from the host computer which are based on the virtual disk structure, e.g., from the file system or logical volume manager level, into one or more requests corresponding to how data is stored on the actual physical storage devices 540A-540D of the storage system 500. The host adapter 520 can be implemented in any of a number of ways, including using a general purpose processor or a custom hardware implementation. In addition, multiple host adapters may be included to facilitate having additional I/O channels for the storage system 500.

The host adapter 520 communicates with the other components of the storage system 500 using bus 530. The bus 530 may be any suitable communication element, including use of SCSI, ESCON, and other bus protocols.

Access to the physical storage devices 540A-540D is controlled through the use of disk adapters 550A-550D. The disk adapter 550A-550D can also be implemented using a general purpose processor or custom hardware design. In the embodiment illustrated in FIG. 5, a disk adapter is provided for each physical storage device. A disk adapter can, of course, have more than one storage device attached to it. In addition, disk adapters may include secondary connections to the physical storage devices of another disk adapter. This permits recovery from failure of one disk adapter by shifting its functions to the second disk adapter.

In the embodiment of FIG. 5, reading and writing to the physical storage device 540A-540D through the disk adapters 550A-550D is facilitated through use of a cache 560. The cache 560 may be a random access memory having greater speed than the disk drives. When reading data, if the data is being temporarily stored in the cache, the read request can be fulfilled more quickly by taking the data from the cache 560. Similarly, when writing data, the data to be written can be stored in the cache. The other components of the system can proceed, while the data is written from the cache to the applicable physical storage device.

Any of a variety of mechanisms can be used to implement and manage the cache 560. An example of such a mechanism is included in U.S. Pat. No. 5,537,568, entitled “System for Dynamically Controlling Cache Manager Maintaining Cache Index and Controlling Sequential Data Access,” issued on Jul. 16, 1996.

Similarly, writes may be accomplished through the cache 560 using any of a variety of mechanisms and strategies. One mechanism for writing from the cache is to store the data to be written in the cache, and mark a “write pending” bit. When the write pending bit is encountered, the applicable data can be written to the disk. This technique is described generally in U.S. Pat. No. 5,341,493, entitled “Disk Storage System with Write Preservation During Power Failure,” issued on Aug. 23, 1994. Of course other known mechanisms may be used to manage the cache 560 without departing from the spirit and scope of the present invention.

The cache 560 may be divided into more than one area. For example, the cache 560 may include an area 560A for storing data being read or written from physical storage devices 540A-540D. The cache may further include a “mailbox” area 540B. The mailbox area 540B may be used to facilitate communications among the disk adapters 550A-550D and with the host adapter 520. For example, each disk adapter 550A-550D may have its own area within the mailbox 560B. Each of the disk adapters 550A-550D can post or read information from the applicable mailbox area 560B, to communicate status and other information.

A remote adapter 570 may also be attached to the bus 530 of the storage system 500. The remote adapter 570 may be employed for communication with remote data facilities (“RDF”), for example, connection to another storage device to maintain a mirror redundancy group. One form of RDF link and method of implementation is described in various publications available from EMC Corporation, including SYMMETRIX Remote Data Facility Product Manual, P/N 200-999-554, rev. B, June 1995. RDF embodiments are also described in U.S. Pat. No. 5,544,347 (Yanai) which is hereby incorporated herein by reference in its entirety. It should be appreciated, however, that the present invention is not limited to the use of RDF or to a system that employs SYMMETRIX disk arrays, and can be employed with any of numerous other types of storage systems.

A service processor 580 may be coupled to the bus 530 of the storage system 500. The service processor 580 may include a display, keyboard and other I/O devices to permit an operator to use the service processor 580 for configuring the components of the storage system 500 and for running or initiating diagnosis and maintenance facilities.

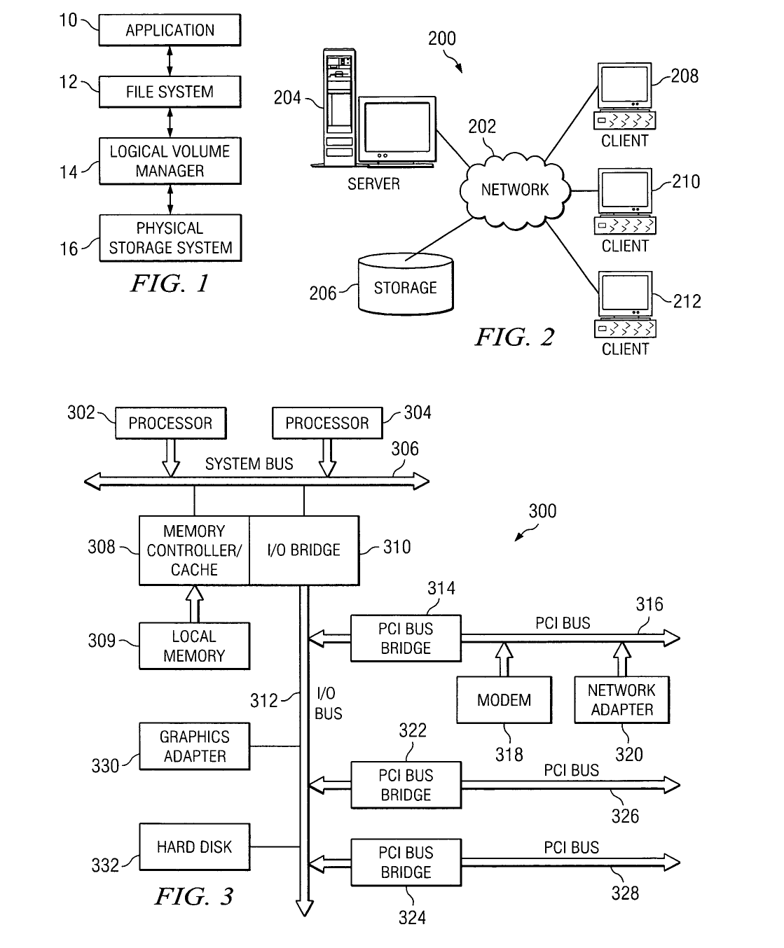

The storage system 500 of FIG. 5 is an example of a storage system that may be used to implement the physical storage system 16 of FIG. 1. As mentioned previously, a problem exists in the architecture shown in FIG. 1 in that a consistency between a state of the file system and log devices at the point in time of a backup operation may not be maintained. Thus, the file system and the log devices have different states and a corruption of data is possible. This is because write operations to the log devices, i.e. the physical storage devices, may be performed during the backup operation and the result being a copy of the log and metadata in the file system for the log devices being different than the actual data stored on the log devices.

When a file system and journal log reside on more than a single device, starting a point in time, or instant, copy of those devices can cause the log and the file system to be out of sync without having the benefits of the present invention. That is, without the present invention, the log can continue to be written to and the state of the file system can drift away from what the log indicates it is. This is also true of a log that is contained on multiple devices, as in the case of striping or simply a large log. The present invention provides a mechanism for keeping the log and the file system consistent even when the log is written across a plurality of devices.

The present invention solves this problem by including a mechanism either within or associated with the logical volume manager that suspends write operations to the log devices of a logical volume during a backup operation. With the present invention, write operations to the log devices of the logical volume are held at a logical volume manager device driver level for the duration of the backup of the log devices. Since no new write operations are allowed to be sent to the storage system for the log device, the “log device” being a logical storage device that may be comprised of a plurality of physical storage devices, new metadata transactions to the file system are also prevented during the same time period. This guarantees internal consistency between the file system and log devices while still allowing write access to blocks in files that already have committed allocations.

Thus, through the operation of the present invention, write operations are permitted to log devices that are not part of the current backup operation but are suspended to other log devices of the storage system that are subject to the backup operation. The write operations are permitted to be sent to the file system log, however, those that need to be suspended because they are directed to log devices that are subject to a backup operation, are held by the logical volume manager until after the backup operation is completed. As a result, write I/O operations are permitted to continue during a backup operation in such a manner that the consistency of the file system metadata is maintained.

In order to suspend write I/O operations during the backup operation, e.g., a point-in-time backup operation, the logical volume manager of the present invention stores any write I/O operations received during the backup operation in a hold queue, e.g., a linked list, within the logical volume manager. As a result, the write I/O operation is not performed on the physical storage devices of the logical volume until after the backup operation is complete. Once the backup operation is complete, the write I/O operations are released from their suspended state in the hold queue and are performed in the order they were received. Thus, during the backup operation, write I/O operations are permitted to be received in the file system log but are not permitted to be sent to the log devices.

As a consequence of the above operation, the metadata of the file system is not changed during the backup operation. Since the write I/O operations are not completed during the backup operation, the file system metadata is not updated to reflect these write I/O operations until after the backup operation is complete and the write I/O operations are performed on the storage system.

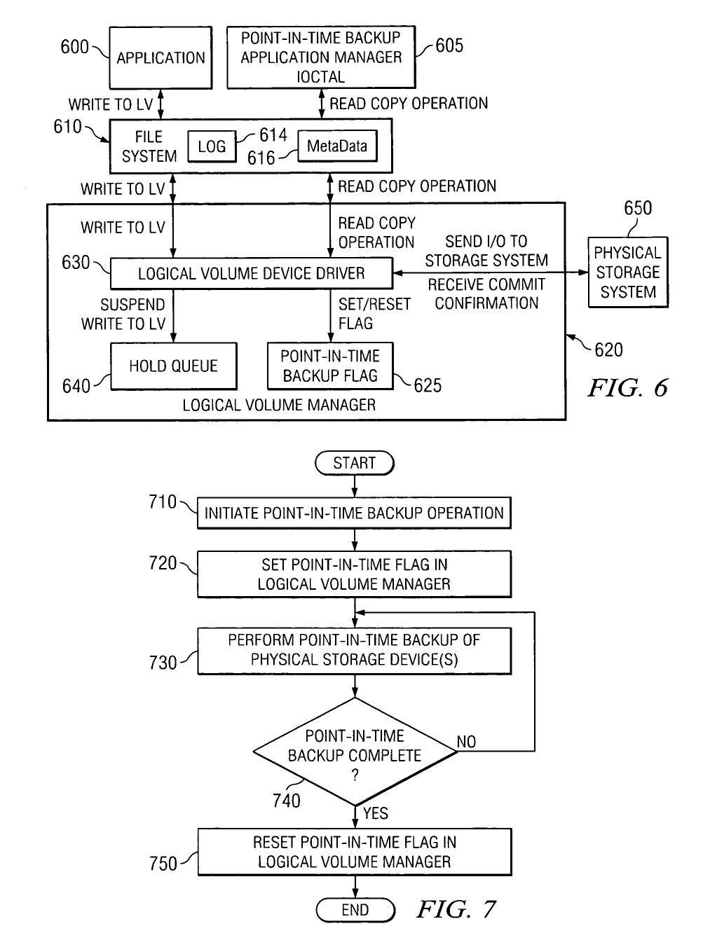

FIG. 6 is an exemplary diagram illustrating the primary operational components of the present invention. As shown in FIG. 6, a file system 610, logical volume manager 620 and a physical storage system 650 are provided as the primary operational components in which the present invention is implemented. The present invention involves the cooperation of the file system 610, the logical volume manager 620, and the physical storage system 650 in suspending write I/O operations to the physical storage devices of the physical storage system 650 during a backup operation. This cooperation is governed by new mechanisms provided within the logical volume manager 620.

The present invention will be described in terms of hardware point-in-time backup operations which are also sometimes referred to as instant copy operations, snapshot copy operations, and the like. It should be appreciated that the present invention may be utilized with other backup operations other than point-in-time backup operations, instant copy operations, or snapshot copy operations, without departing from the spirit and scope of the present invention.

A point-in-time backup operation is a backup of the entire contents of a storage device or storage devices, e.g., disk or disks. Thus, it is important that the metadata stored in the file system log correspond to the data on the physical storage devices or else data corruption may occur. As a result, it is important to ensure that data is not written to the physical storage blocks containing the file system log during the point-in-time backup operation since such write I/O operations would cause the data on the physical storage devices to not match the metadata of the point-in-time backup copy.

The mechanisms of the present invention ensure that write I/O operations are not permitted to be sent to the physical storage system 650 blocks containing the file system metadata during a point-in-time backup operation by providing a point-in-time backup flag 625, on a per logical volume basis, additional functionality in the logical volume device driver 630, and hold queue 640 of the logical volume manager 620, as described in greater detail hereafter. Through the use of these new mechanisms and functionality, write I/O operations that are received during a point-in-time backup operation are suspended for the file system log logical volume until after the point-in-time backup operation is completed. In this way, no write operations may be performed in the physical storage system 650 associated with the log logical volume during the point-in-time backup operation and thus, the metadata associated with the data in the physical storage devices of the physical storage system 650 is ensured to be consistent with the data.

As shown in FIG. 6, a point-in-time backup application 605 may initiate a point-in-time backup operation and send a read copy operation to the file system 610. The read copy operation is provided to a logical volume manager 620, and more specifically, a logical volume device driver 630 of the logical volume manager 620. The logical volume device driver 630 is a pseudo-device driver that manages and processes all I/O operations to the physical storage system 650.

In response to receiving a read copy operation indicating that a point-in-time backup operation has been initiated, the logical volume device driver 630 sets a point-in-time backup flag 625 indicating that a point-in-time backup operation is being performed. The read copy operation is then logged in the log 614 and the read is permitted to be sent to the physical storage system 650.

Other applications are permitted to submit I/O requests to the file system 610 during the point-in-time backup operation. With the present invention, if the submitted I/O request is a Read I/O request, then the I/O request is permitted to be processed in a normal fashion. If the submitted I/O request is a Write I/O request that will result in a change to the file system metadata and a write to the file system log, however, the Write I/O request is suspended by the mechanisms of the present invention until after the point-in-time backup operation is completed.

Thus, for example, the application 600 may send a Write I/O request to the file system 610 which then generates a log entry associated with the Write I/O request in the file system log 614 and provides the Write I/O request to the logical volume manager 620. The logical volume device driver 630 receives the Write I/O request and determines it to be a Write I/O request. As a result, the logical volume device driver 630 reads the value for the point-in-time backup flag 625 to determine if the flag has been set or not. If the flag has not been set, then the Write I/O request is processed in a normal fashion by writing an entry to the file system log 614 for the Write I/O request and sending the Write I/O request to the physical storage system 650 so that the physical storage devices may commit the Write I/O operation. Once the Write I/O operation has been committed, the log entry in the file system log 614 is used to update the file system metadata 616.

If however, the point-in-time backup flag 625 has been set, i.e. a point-in-time backup is in progress, then the Write I/O request is sent to the hold queue 640. The hold queue 640 may be, for example, a linked list of I/O requests that have been suspended and which are to be performed once their suspend state has been removed. Any I/O requests that are suspended by placing them in the hold queue 640 are not sent to the physical storage system 650 until the I/O request entries in the hold queue 640 are released.

Once the point-in-time backup operation is completed, the point-in-time backup application 605 sends a message, or alternatively, the file system 610 sends a message, to the logical volume manager 620 indicating the completion of the point-in-time backup operation. Upon the logical volume device driver 630 receiving a message from the point-in-time backup application 605, or the file system 610, that the backup operation is complete, the logical volume device driver 630 resets the point-in-time backup flag 625 and releases the I/O requests stored in the hold queue 640. These I/O requests are then submitted to the physical storage system 650 in the order that they were received so that they may be committed. Once the I/O requests are committed, the logical volume manager 620 is informed of the committing of the I/O requests, and the metadata in the log entry of the file system log 614 corresponding to the I/O request is used to update the file system metadata 616.

Thus, with the present invention, Write I/O operations to the physical storage devices of a storage system are suspended for the blocks containing the file system log logical volume for the duration of the backup operation. In this way, the metadata associated with the data stored on the physical storage devices is ensured to be consistent with the data. As a result, the log will match the file system so that the log can be replayed. This means that file system metadata 616 will match the file system log 614 and thus, the metadata 616 can be trusted after the log 614 is replayed. A file system can be considered corrupted and possibly lost if the state of its metadata 616 is not maintained. If the state is maintained then the backup has valid metadata 616 if it is not maintained then the backup is not valid. One goal, and one principal benefit, of the present invention, is to obtain a valid backup by ensuring the validity of the file system metadata.

FIGS. 7-9 are flowcharts that illustrate various exemplary operations according to the present invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 7 is a flowchart outlining an exemplary operation of the present invention with regard to setting and resetting a point-in-time backup flag in a logical volume manager. As shown in FIG. 7, the operation starts by a point-in-time backup operation being initiated (step 710). The point-in-time backup flag is set in the logical volume manager in response to the point-in-time backup operation being initiated (step 720).

The point-in-time backup operation is then performed on one or more of the physical storage devices (step 730) and a determination is made as to whether the point-in-time backup operation has completed (step 740). If not, the operation returns to step 730 and the point-in-time backup operation is continued. If the point-in-time backup operation has completed, then the point-in-time flag in the logical volume manager is reset (step 750) and the operation terminates.

FIG. 8 is a flowchart outlining an exemplary operation of the present invention with regard to suspending a write I/O operation during a backup operation. As shown in FIG. 8, the operation starts with a Write I/O request being received (step 810). A log entry is added to the log of the file system for the Write I/O request that is received (step 815). In response to receiving a Write I/O request, the point-in-time backup flag is read to determine if it has been set or not (step 820).

A determination is made as to whether the point-in-time backup flag has been set (step 830). If not, the Write I/O operation is processed in a normal fashion by submitting it to the storage system to be committed (step 840). If the point-in-time backup flag is set, the Write I/O operation is sent to a hold queue in the logical volume manager (step 850). The operation then terminates.

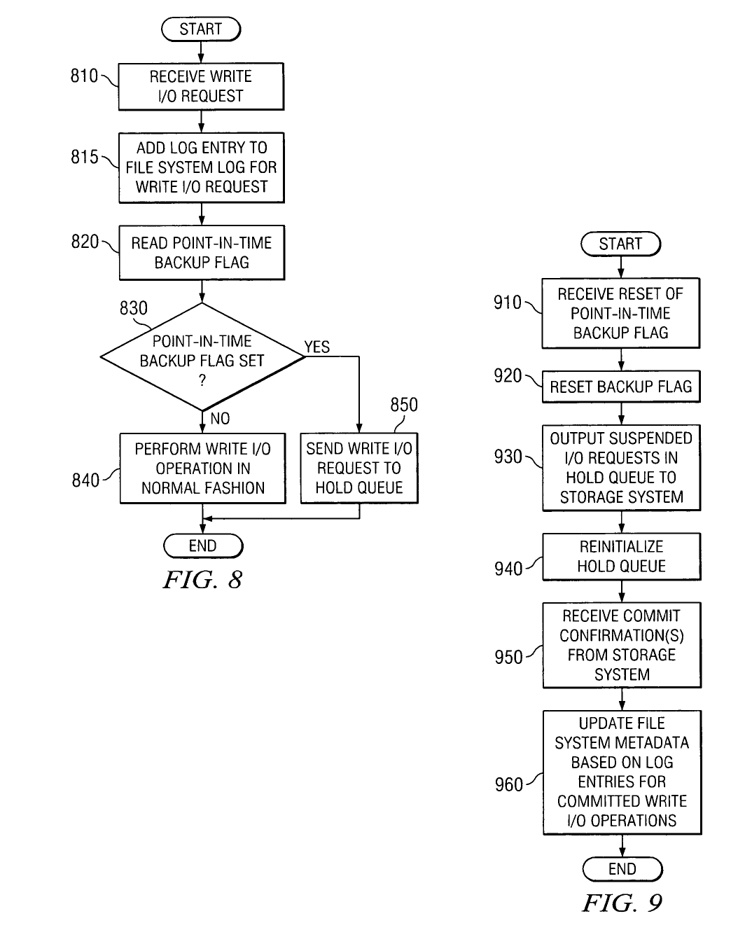

FIG. 9 is a flowchart outlining an exemplary operation of the present invention with regard to releasing suspended write I/O operations in a hold queue of a logical volume manager. As shown in FIG. 9, the operation starts by receiving a reset of the point-in-time backup flag (step 910). The backup flag in the logical volume manager is reset to an “unset” state (step 920).

The write I/O requests in the hold queue are then output to the storage system in the order that they were received (step 930) and the hold queue is reinitialized (step 940). The ordering of the write I/O operations may be maintained by the structure of the hold queue, for example. That is, a linked list may be utilized that maintains the ordering of received write I/O requests.

As each write I/O operation is committed by the storage system, a confirmation that the write I/O operation is committed is received (step 950). As a result, the entry in the file system log that corresponds to the write I/O is used to update the file system metadata (step 960). The operation then terminates.

Thus, the present invention provides a mechanism for ensuring the consistency of a journaled file system metadata with the data stored in an associated storage system during a backup operation being performed on the storage devices of the storage system. As a result, data corruption is less likely due to Write operations being performed during the backup operation.

While the present invention is described in terms of all write I/O operations to log devices being held by the logical volume manager during the backup operation, the present invention is not limited to such. Rather, in an alternative embodiment, the write I/O operations may be held only when they correspond to a designated range of blocks of data. Thus, even though the backup operation is current being performed, if the write I/O operation is to a block of data that is not within the designated range, such as to a different logical volume, the write I/O operation will not be held by the mechanisms of the present invention.

For example, when a backup operation is initiated, the blocks of data that are subject to the backup operation may be determined, i.e. the range of blocks of data that are being backed up are identified. Thereafter, if a write I/O operation is received, during the backup operation, that is directed to this range of blocks of data, the write I/O operation will be suspended in the manner previously described. However, any write I/O operations that are not directed to this range of blocks of data will be allowed to proceed in a normal fashion since they will not affect the metadata of the blocks of data that are being backed up. Thus, in this alternative embodiment, rather than suspending all write I/O operations during a backup operation, only those write I/O operations that affect the metadata of one or more blocks of data subject to the backup operation are suspended.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of handling Write input/output (I/O) requests during a backup operation on at least one storage device, comprising:
receiving a Write I/O request for performing a Write I/O operation to a logical volume, wherein at least a portion of the logical volume resides on the at least one storage device;
logging the Write I/O request in a file system log indicating that the Write I/O request is being submitted to the at least one storage device;
determining if a backup operation is being performed on the at least one storage device; and
suspending the Write I/O operation in a logical volume manager until after the backup operation is completed if it is determined that the backup operation is being performed, wherein Write I/O operations to at least one other logical volume are not suspended during the backup operation.

2. The method of claim 1, wherein suspending the Write I/O operation includes:
storing the Write I/O request in a hold queue in the logical volume manager, wherein the Write I/O request is not forwarded to the at least one storage device while the Write I/O request is in the hold queue.

3. The method of claim 1, wherein determining if a backup operation is being performed includes:
determining if a backup flag is set in a logical volume manager.

4. The method of claim 3, wherein the backup flag is set in response to receipt of a message from a backup application indicating that a backup operation has been initiated.

5. The method of claim 1, wherein the backup operation is a point-in-time backup operation.

6. The method of claim 2, further comprising:
receiving a message indicating that the backup operation is complete; and
releasing the Write I/O request from the hold queue in response to receiving the message; and
submitting the Write I/O request to the at least one storage device.

7. The method of claim 2, wherein the hold queue is a linked list in which Write I/O requests are stored in an order in which they are received by the logical volume manager.

8. The method of claim 6, wherein Write I/O requests in the hold queue are released from the hold queue in an order in which they were received by the logical volume manager.

9. The method of claim 6, further comprising:
updating file system metadata based on the file system log only after the backup operation is complete and the Write I/O operation is released from the hold queue.

10. The method of claim 1, wherein the Write I/O request is suspended only if the Write I/O request is for a Write I/O operation that would result in a change in file system meta data.

11. The method of claim 1, wherein the Write I/O request is suspended only if the Write I/O request is to a block of data that is subject to the backup operation.

12. A computer program product in a computer readable medium for handling Write input/output (I/O) requests during a backup operation on at least one storage device, comprising:
first instructions for receiving a Write I/O request for performing a Write I/O operation to a logical volume, wherein at least a portion of the logical volume resides on the at least one storage device;
second instructions for logging the Write I/O request in a file system log indicating that the Write I/O request is being submitted to the at least one storage device;
third instructions for determining if a backup operation is being performed on the at least one storage device; and
fourth instructions for suspending the Write I/O operation in a logical volume manager until after the backup operation is completed if it is determined that the backup operation is being performed, wherein Write I/O operations to at least one other logical volume are not suspended during the backup operation.

13. The computer program product of claim 12, wherein the third instructions for suspending the Write I/O operation include:
instructions for storing the Write I/O request in a hold queue in the logical volume manager, wherein the Write I/O request is not forwarded to the at least one storage device while the Write I/O request is in the hold queue.

14. The computer program product of claim 12, wherein the second instructions for determining if a backup operation is being performed include:
instructions for determining if a backup flag is set in a logical volume manager.

15. The computer program product of claim 14, wherein the backup flag is set in response to receipt of a message from a backup application indicating that a backup operation has been initiated.

16. The computer program product of claim 12, wherein the backup operation is a point-in-time backup operation.

17. The computer program product of claim 13, further comprising:
fourth instructions for receiving a message indicating that the backup operation is complete; and
fifth instructions for releasing the Write I/O request from the hold queue in response to receiving the message; and
sixth instructions for submitting the Write I/O request to the at least one storage device.

18. The computer program product of claim 13, wherein the hold queue is a linked list in which Write I/O requests are stored in an order in which they are received by the logical volume manager.

19. The computer program product of claim 17, wherein Write I/O requests in the hold queue are released from the hold queue in an order in which they were received by the logical volume manager.

20. The computer program product of claim 17, further comprising:
seventh instructions for updating file system metadata based on the file system log only after the backup operation is complete and the Write I/O operation is released from the hold queue.

21. The computer program product of claim 12, wherein the Write I/O request is suspended only if the Write I/O request is for a Write I/O operation that would result in a change in file system meta data.

22. The computer program product of claim 12, wherein the Write I/O request is suspended only if the Write I/O request is to a block of data that is subject to the backup operation.

23. An apparatus for handling Write input/output (I/O) requests during a backup operation on at least one storage device, comprising:
means for receiving a Write I/O request for performing a Write I/O operation to a logical volume, wherein at least a portion of the logical volume resides on the at least one storage device;
means for logging the Write I/O request in a file system log indicating that the Write I/O request is being submitted to the at least one storage device;
means for determining if a backup operation is being performed; and
means for suspending the Write I/O operation in a logical volume manager until after the backup operation is completed if it is determined that the backup operation is being performed, wherein Write I/O operations to at least one other logical volume are not suspended during the backup operation.
